(19) United States
(12) Patent Application Publication
(10) Pub. No.: US 2013/0346130 A1
(43) Pub. Date: Dec. 26, 2013

(54) GEOGRAPHICAL CLUSTERING OF SERVICE PROVIDERS

(71) Applicant: Moose Loop Holdings, LLC, Salt Lake City, UT (US)

(72) Inventor: Ken R. Davis, Salt Lake City, UT (US)

(73) Assignee: Moose Loop Holdings, LLC, Salt Lake City, UT (US)

(21) Appl. No.: 13/705,746

(22) Filed: Dec. 5, 2012

Related U.S. Application Data
(60) Provisional application No. 61/569,599, filed on Dec. 12, 2011.

(51) Int. Cl. G06Q 10/06; G06Q 40/04

(52) U.S. Cl. CPC G06Q 10/063116; G06Q 40/04
USPC 705/7.14; 705/37; 705/7.16

(57) ABSTRACT

Technology is described for customer exchange, route efficiency determinations, and new customer assignments. The method of customer exchange can include identifying a customer of an originating service provider; assessing a relative proximity of the customer with respect to location; receiving input from the originating service provider regarding their permission to trade the customer; reassigning the customer to the new service provider based on permission of the originating service provider the assessed relative proximity or location; and notifying the new service provider of an exchange of the customer using the processor.

### RELATED APPLICATION

This application claims the benefit of U.S. Provisional Patent Application Ser. No. 61/569,599, filed Dec. 12, 2011, which is incorporated herein by reference in its entirety.

### BACKGROUND

Many goods can be purchased in a commoditized way. A consumer can have certain criteria when deciding to purchase goods and if the goods meet desired criteria, then the consumer often does not care who provides the goods, making these certain types of goods a commodity. However, to consider the goods a commodity, there is often also a market offering to sell the goods. Typically, the market establishes a fixed price for the goods, at which point the goods can be obtained without bargaining, bidding, or auction.

Services have traditionally been less commoditized. Rather, services are typically purchased after comparing service providers to one another. For example, service providers can be compared through a bidding process, interviews, and/or online user feedback ratings. Even such service provider comparisons can be challenging for a consumer to interpret due to the non-uniformity in services supplied by various service providers and the unfortunate ability for the services providers themselves to “game” the systems (e.g. supplanting user feedback and ratings systems with their own self-serving feedback and ratings). This has resulted in uncertainty to the consumer as to the comparative cost of services, reliability of services, and the quality of services provided by service providers.

Another challenge associated with the sale and purchase of services can be found on the side of the service provider. Although consumers can readily compare the service providers and their respective offerings, inefficiencies relating to the actual servicing of the consumers can arise for the service provider. For example, a real challenge for service providers is that they are frequently competing on cost alone, and rarely on quality of service (which is more subjective and therefore harder for the customer to judge). The service provider also tends to waste a considerable period of time which could be used performing actual tasks or work, thereby increasing billable hours. If the average billable hours could be increased, the contractor could still work the same number of hours, but instead of spending time doing non-billable bidding and other customer management, the service provider could spend more time doing actual billable work.

### BRIEF DESCRIPTION OF THE DRAWINGS

FIG. 1 is a block diagram illustrating an example of a system for exchanging customers between one or more service providers.

FIG. 2 illustrates an example of a general method of exchanging customers between one or more service providers based in part on geographic proximity.

FIG. 3 is a flowchart illustrating an example method for exchanging customers between service providers.

FIG. 4 is a flowchart illustrating an example method for exchanging customers between service providers.

FIG. 5 is a block diagram illustrating an additional example of a system for exchanging customers between one or more service providers.

FIG. 6 is a flowchart illustrating an example method for computing route efficiency to adjust scheduling of tasks based on travel time and estimated fuel consumption.

FIG. 7 is a flowchart illustrating an example method for efficiently incorporating a new customer into a service provider's service schedule.

### DETAILED DESCRIPTION

Reference will now be made to the examples described herein and illustrated in the drawings, and specific language will be used herein to set forth the same. It will nevertheless be understood that no specific limitation of the scope of the technology is thereby intended. Alterations and further modifications of the features described and illustrated herein which would occur to one skilled in the relevant art and having possession of this disclosure are to be considered within the scope of the description.

A technology is described for efficiently providing access to services via a networked computer system at fixed prices. More accurate and efficient access to services can be used to commoditize services not traditionally commoditized in the past by allowing the services to be priced and delivered in a more uniform fashion. Such access can be provided by operations implemented in networking and computing device hardware, such as generating a market of service providers for a user selected service from a pool of service providers, acquiring information about services on-line that are tailored to those service providers, and/or applying statistical pricing information from those service providers and/or additional sources. Additional operations, as discussed below, can also be implemented to improve access to services at fixed prices. The improvements can have positive impacts for both the customer and the service provider.

While access may be provided for any of a nearly limitless number of services provided by service providers, examples of commoditization of services may be applied to many areas including various yard, home, or commercial building services, such as: lawn care (e.g., lawn mowing, lawn fertilizing, edging, etc.), basic home repairs, painting, cleaning, gardening, small appliance repair, snow removal, etc. A service provider can be any service provider, contractor, service contractor, service group, or service supply entity that provides a service to a customer.

By generating such a market of service providers, acquiring information about services on-line tailored to those service providers, and/or applying statistical pricing information from those services providers and services, services not traditionally commoditized in the past can be commoditized.

This technology may allow a user to select a service or task (e.g., lawn mowing) to be purchased electronically, and a user interface on a client device can present choices to the customer that include task parameters and other details about the service. These service parameters can be used provide efficient commodity-like pricing. The service parameters may include task details or variables that affect pricing and other factors for the task. In the lawn mowing example, parameters may be collected from a customer that may include: lawn shape and size, length of grass, type of grass, physical location, quality of service provider desired, need for repeat service, etc. Other types of services will have other parameters, as would be appreciated by a service provider. The pricing of the service or task may be a fixed price that is calculated using existing facts about the service and statistical data known about task prices in a geographical area, etc. With iterated services and sufficient service provider and customer feedback, the pricing can become more accurate over time such that each task may become more like a standard unit of work that is priced with increasing accuracy.

It is noted that though lawn mowing or yard work is exemplified herein in many cases, the systems and methods described herein related to any of a number of services, such as, for example, fertilize lawn, mow lawn, aerate lawn, edge lawn, remove debris, prune trees, spring/fall cleanup, pest control, clear snow, clear gutters, clean/maintain pool, collect garbage, wash windows, clean carpets, clean house, paint, evict a tenant, inspect a property, rekey locks, plumbing, electrical, HVAC, sprinklers, handyman services, etc.

Commoditized tasks purchased by a customer through this technology may be matched with one of a plurality of service providers who have schedule availability to perform the task. Customers may have the opportunity to select preferred service providers from a list of available service providers, but the selection of a service provider is optional. A customer may be encouraged to allow the service provider to be assigned automatically using a computing device, and the customer may be encouraged not to select a service provider through various pricing and other inducements. As the services become more commoditized, then the service providers become more easily interchangeable. This may provide an experience similar to a customer's experience in a retail setting where the customer is more interested in the availability, proximity, reliability, and the quality of the goods received than which individual made the goods being purchased.

Service providers can be matched to customers on the basis of a number of additional parameters identified by the service providers and these parameters may include: shortest distance to customer from the service provider's base location or from one or more of a service provider's existing customers, higher schedule availability, matching skill level, quality level desired, and/or other parameters. The value provided to service providers may be increased by providing more customers, assigning customers situated closer together, automated pricing, back office accounting and management functions, and other ways that improve service provider efficiency and/or boost service provider revenues.

Using a commodity approach can simplify the service purchase process and can make buying services more analogous to buying tangible goods through a retail store. Detailed methods may be used to compute fair market pricing for the service based on customer provided specifications about the service to be performed. The fair market pricing can allow a fixed price to be presented to the customer, at the point of sale, and allow the customer to complete a transaction immediately.

One of the most commonly reported challenges among service providers is that they often end up servicing customers that are outside of a common service area. This creates a number of challenges including: (1) the service provider's responsiveness to other customers suffers as they frequently find themselves outside of the range where they can quickly return to one of their customers to fix small problems; (2) the drive time to and from the customers outside of the common service area eat into valuable time that could be spent servicing additional customers; and/or (3) the extra fuel and material costs frequently make servicing out of area customers less profitable.

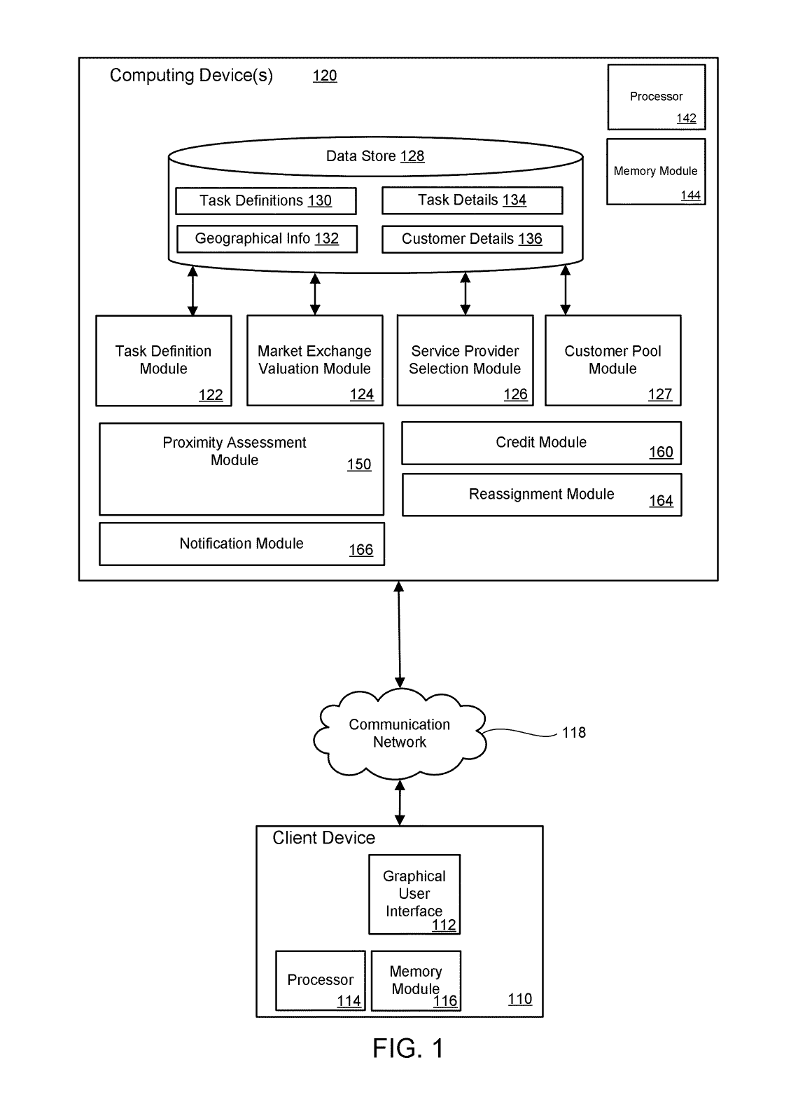

As illustrated in FIG. 1, a system can be used for delivering, pricing, assigning, managing, and/or exchanging tasks or customers. The system may include a client device 110 through which a user can access information related to tasks and customers over a communications network 118. The communications network can be a local area network (LAN), wide area network (WAN), or the internet, for example. A graphical user interface 112 can be provided to the user using the client device 110 to access the task, customer, and related information located on a separate computing device 120. A client device 110 with a graphical user interface 112 may be used by either a service provider or a customer.

Parameters for a task that the customer desires to be performed can be received by the graphical user interface 112 of the client device 110. For example, the customer may type, speak, write, or select task parameters that the client device 110 can capture. Payment for the task selected by the customer may also be supplied via the graphical user interface. In one example, payment via a credit card or debit transaction is collected before the task is assigned to a service provider for performance. The client device may include a processor 114 and a memory module 116. A client device 110 may be a device such as, for example, a desktop computer, a laptop, a tablet, a mobile device, a television, a cell phone, a smart phone, a hand held messaging device, a set-top box, a gaming console, a personal data assistant, an electronic book reader, heads up display (HUD) glasses, or any device with a display that may present the graphical user interface 112.

The parameters for a task collected by the client device 110 can be sent to a computing device 120. The computing device 120 may be provided with modules for providing and managing tasks and customers. Additional related functions for communication, service provider selection, customer reassignment or exchange, task exchange, proximity assessments, and customer valuation, can also be provided, as will be described later. The computing device 120 may be a single server, a distributed server environment, a server farm, or any computing device or group of computing devices that may service requests from other computing devices or programs. In addition, the computing device may include one or more processors 142 and memory modules 144.

The parameters that are requested from the customer can be collected and used by a task definition module 122. The task definition module 122 can also obtain a task definition for a task which describes task details to be performed for a customer. In addition, the task definition module 122 can access the task definitions 130 located in the data store 128, and the task definitions may include specific definitions of what procedures are going to be undertaken for a task. For example, the task definition can define a lawn mowing taskf as: 1) cutting grass, and 2) blowing loose grass off sidewalks. The task definition may also include a question template to send to customers to obtain the factual task parameter information that is desired to be captured from the customer about a task type. The customer's replies and specific factual data collected in response to the questions about tasks can be stored in the task details 134 data store. The data store 128 may refer to any device or combination of devices capable of storing, accessing, organizing, and/or retrieving data, which may include any combination and number of data servers, relational databases, object oriented databases, simple web storage systems, distributed storage systems, data storage devices, data warehouses, flat files, and data storage configuration in any centralized, distributed, or clustered environment. The storage system components of the data store may include storage systems such as a SAN (Storage Area Network), cloud storage network, volatile or non-volatile RAM, optical media, or hard-drive type media, for example.

Additional input parameters related to the customer may also be obtained automatically from third parties. For example, information associated with the tasks such as a house lot size, square footage of the house, number of bedrooms and bathrooms, and related real property information can be obtained for a real estate information service provider. Similarly, mapping data and address correction data can be obtained from a mapping information service provider. Weather data can be obtained from a weather information source (e.g., for snow clearing predictions) including but not limited to: snow accumulation periodic actual measurements along with future predictions, and/or temperature and humidity for estimating snow ablation.

Each customer can be given a market exchange valuation value based on the customer details utilizing the market exchange valuation module 124. The market exchange valuation can be based on parameters associated with the customer that have been collected by the customer details module 134. The customer details module can include information related to the task(s) associated with the customer, the frequency of performance of each task, the timeliness of past payments from the customer for tasks performed, the length of time the customer has been a customer, the number of other tasks the customer has order in the past, or any measures related to the quality of the customer. The market exchange valuation module 124 can provide a value associated with each of the customers based on one or more of the customer details and can be utilized as a basis for exchanging customers between two or more service providers. When the market exchange valuation is performed, the market exchange value determined, and the customer exchanged or reassigned, if the originating service provider does not receive a traded new customer, the originating service provider can be given a credit associated with the exchange of that customer. The credit can be determined and assigned by the credit module 160. Similarly, a new service provider that receives a reassigned customer but does not trade or exchange a customer can be assessed a debit by the credit module 160. In a similar but related example, the system can also be used to create a true bid/ask spread, and thus, “make” a market based on these credits. For example, the buy price of customers can be be slightly higher than the sell price of customers so that TaskEasy can monetize the trading and profit from each transaction, much the way a market maker in the stock market makes a little bit of money each time they match a buyer with a seller.

Service provider feedback about customers can help refine market exchange values for a customer. In some cases, there may be unexpected aspects of a task that occur with certain customers or certain types of tasks for the customers. For example, edging a customer's lawn may be more difficult the first time where the customer has a very overgrown lawn. Customer feedback about service providers (quality, timeliness, speed, etc.) and/or or service provider feedback about the customer (timeliness of payment, ease of accomplishing task based on customer cooperation, etc.) may also be used to refine the market exchange valuation as well as the ultimate reassignment of the customer to a new service provider in an exchange.

An originating service provider may be selected from among the plurality of service providers having customers and desiring to participate in a trade or exchange of customers. It is noted herein that the term “originating service provider” does not infer that the current service provider is in fact the very first service provider. For example, an “originating” service provide can also mean the existing service provider, whether it be the first, second, third, etc., service provider to provide services to that customer or for that task. “Originating” is more of a relative term as it relates to any “new service provider.” The originating service provider is the party who gives up the customer, and the new service provider is the party who receives the new customer. That being stated, it is also noted that a single service provider can be both an originating service provider and a new service provider in a customer exchange, whether or not that exchange is directly between two service providers, or as a result of several service providers shifting customers around through the exchanges described herein. That being clarified, the service provider selection can take place using the service provider selection module 126. Customers can be made available for exchange based on desire of the originating service provider to trade the customer. In one aspect, a processor can do an assessment based on the relative proximity of a service provider's customers, customer details and geographical information, and identify potential customers whose geographic location may make them good candidates for exchange or reassignment and notify the service provider. This assessment can be reported using a notification module 166. The assessment of potential customer candidates for exchange can be done automatically on a predetermined schedule or can be done on the request of one or more service providers. In this example, an originating service provider may have the opportunity to provide input regarding the permission to trade customers, prioritized in order of relative proximity, with other service providers.

One method for assessing whether a service provider should offer a customer for trade or exchange can be through the use of the K-means method with outliers where K is the number of potential new service providers that will be performing the work. This logically separates the data first into the K most efficient groupings of customers and then then locates outliers that are ranked according to those that create the most excess travel for the service provider.

Another possible method for determining possible candidate customers for trade or exchange can be through the use of the OPTICS (“Ordering Points To Identify the Clustering Structure”) method. This is a variant of DBSCAN (“Density-Based Spatial Clustering of Applications with Noise”), which doesn't require that one know the number of clusters in the population. This might also be used to help suggest to a service provider recognize that a new unit or team can or should be formed to service a particular area with a geographical center. Outliers can still be identified and ranked according to those that create the most travel inefficiency for the service provider. Once the outliers are identified, the service provider can choose which of the outliers he may like to trade with one or more other service providers or the service provider can automate the trading of customers or tasks based on pre-configured paramaters.

Additional potential new service providers for a customer can also be identified utilizing the service provider selection module 126. Criteria for selecting potential new service providers may include using at least one of the following: a distance between the service provider and customer, distance between the potential new service providers customers and the customer being traded, time slots made available by the service provider, a skill level of service requested, previous performance feedback of the service provider from prior customers, quality tier of a service provider, etc. Other criteria or metrics about service providers may also be used in selecting a service provider, as desired. The relative proximity of each potential new service provider can be assessed using the proximity assessment module 150. This module can utilize some of the same methods discussed above in order to determine whether a particular customer would be a good fit for the service provider or whether the new customer would be an outlier.

Customers can be reassigned from an originating service provider to a new service provider based on the permission of the originating service provider and the assessed relative proximity of the customer to the new service provider or the new service provider's other customers. The reassignment can be done using the reassignment module 164.

The customer and the new and originating service providers can be notified of the exchange or reassignment of the customer to the new service provider using the notification module 166. In one example, the notification module may prepare a web page or a web application page to be sent to the customer. Alternatively, a notification can be sent through the graphical user interface 112 on the client device 110 using an application on the client device 110. Other types of notifications may include: emails, instant messages, text messaging, or any other message type that can be received by the customer. Once the customer has been exchanged and reassigned to the new service provider, then the customer can be scheduled into the new service provider's schedule. More specifically, the customer and associated task can be added to an available time slot on the service provider's schedule, and the customer can be notified of the scheduled task time. The notification module can also prepare other network pages, web pages, or web application pages to communicate other information to the client device 110.

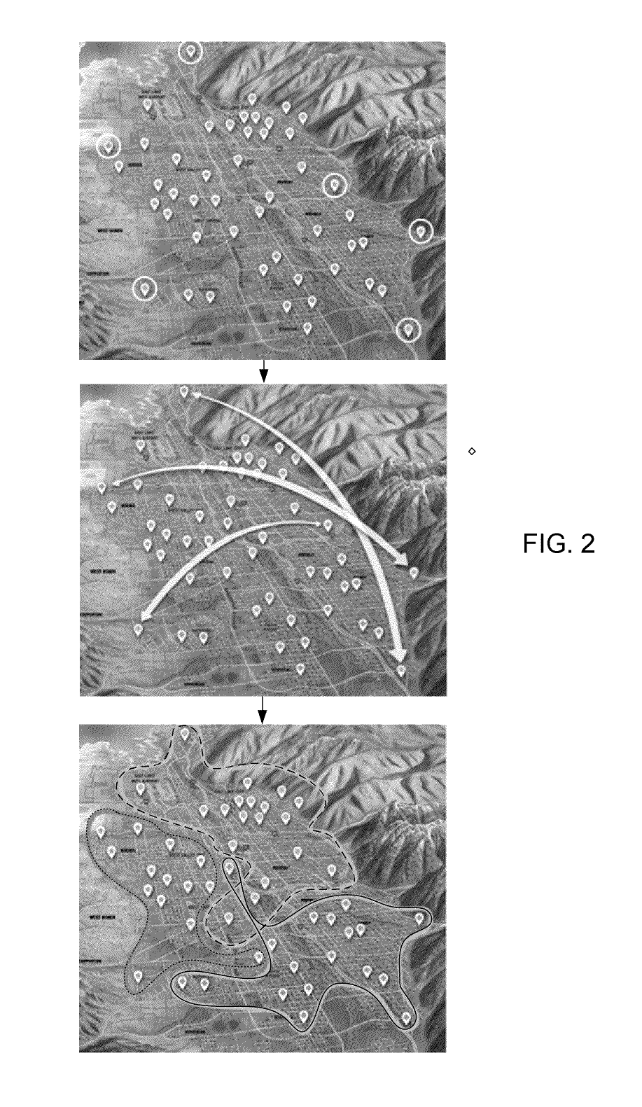

FIG. 2 is a graphical illustration the general principal of customer exchange that can be achieved utilizing the methods disclosed herein. The customer exchange can enhance efficiencies for a service provider by reducing or eliminating customers that are geographical outliers and which otherwise utilize a disproportionate amount of a service provider's available time and resources as compared to the revenue generated by these customers. In one trading example, the service provider may choose to initiate an exchange or trade a customer that is the greatest distance from the service provider's defined territory. The ability to trade customers between service providers can allow the service providers to service more customers in the same time period because the service provider can trade away customers who are a long distance from the service provider's geographical area or base location, or who are a long distance from their customer base. As a result, the service provider may spend less time on travel and travel expenses which can increase the service provider's profitability. In a similar example, a service provider may want a majority of the service provider's customers to be in smaller geographic region but the value of the service provider's current clients may not support such a business. By offering other customers for exchange or trade, a service provider may be able to realize the goal of having an adequate customer base that is within a defined smaller geographic region. The service provider may then become more profitable as a result of such trades and this in turn helps the service provider realize a return on his initial business investment.

As illustrated in FIG. 2, there are three service providers each having a customer base represented by various pin identifiers. Within each pin identifier is a circle, diamond, or star, denoting respective customers of the three service providers. In the top diagram, six customer outliers are shown (circled) as not being grouped closely to other existing customers for each service provider. In the middle diagram, possible exchanges are shown between service providers. In the bottom diagram, the customer base of each service provider is shown after the exchange. The outliers are all reallocated or exchanged to new service providers within a service route that is more compact. The ability for service providers to trade customers using an automated valuation allows the service providers to feel fairly treated during trades. A computerized valuation of a task or customer can provide a more uniform valuation of the customer value each time a valuation is made. This automated valuation can result in faster trades and avoid haggling between the service providers. Since the service providers are trading through an electronic system, the number of service providers with which the selling service provider can trade is increased, and a larger trading pool helps ensure that the trading prices are more likely to be fair.

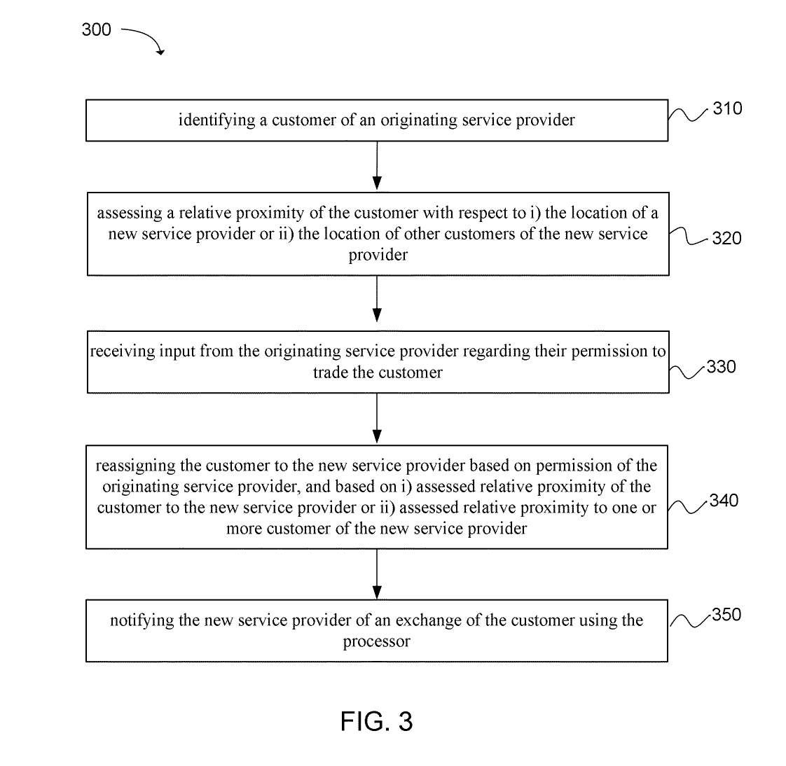

FIG. 3 illustrates embodiments of methods 300 for exchanging customers between service providers in a computing environment. In this example, the method can comprise multiple steps, including identifying 310 a customer of an originating service provider; assessing 320 a relative proximity of the customer with respect to i) the location of a new service provider or ii) the location of other customers of the new service provider, using a processor; and receiving input 330 from the originating service provider regarding their permission to trade the customer. Additional steps can include reassigning 340 the customer to the new service provider based on permission of the originating service provider, and based on i) assessed relative proximity of the customer to the new service provider or ii) assessed relative proximity to one or more customer of the new service provider; and notifying 350 the new service provider of an exchange of the customer using the processor. Optionally, the customer can also be notified similarly of the exchange.

In related examples, there are also ways of dealing with different levels of trading aggressiveness. For example, an originating service provider may be more willing to lose a customer in an attempt to trade the customer, and therefore would like to strongly enforce the trade (e.g. “We are no longer performing services in your area, however, we have identified a service provider that is performing services in your area and have transferred your task to them”). Alternatively, a service provider may rather keep performing services for the customer, however inefficiently, rather than potentially lose the customer (and/or the credit value) all together, and thus, would like to very softly enforce the trade to the customer (e.g. “We are no longer performing services in your area, however we really value you as a customer and are willing to continue to provide this task to you. That being said, we have a trusted partner that also performs your task in your area and we would like your permission to transfer your task to them, would this be okay?”). The system can be set up to include these types of service provider preferences and weight them accordingly when assessing a customer trade.

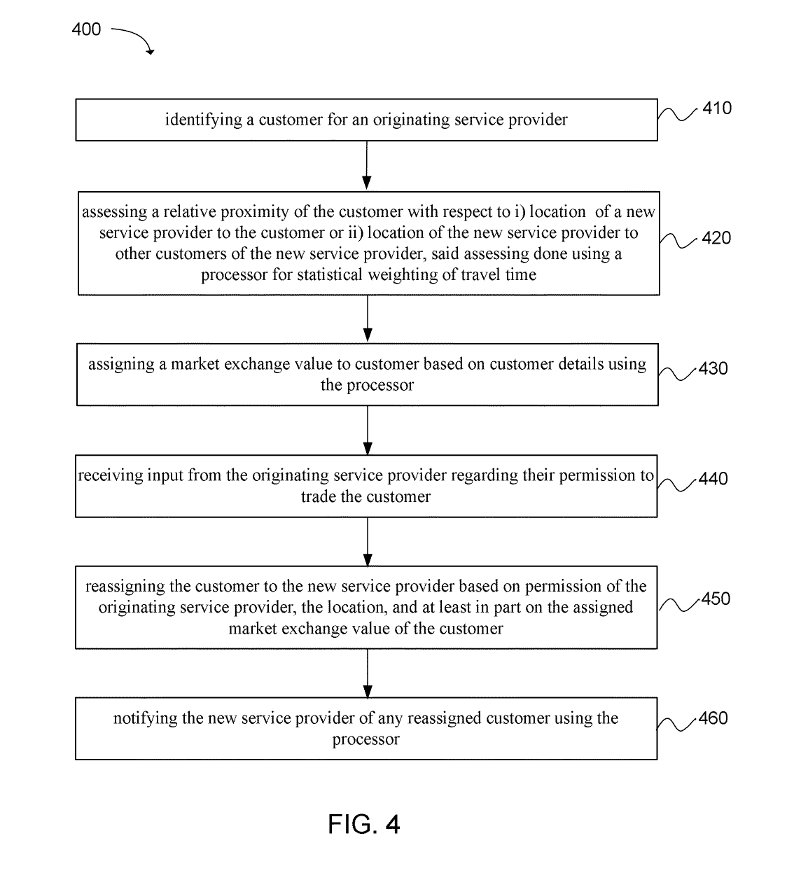

FIG. 4 also illustrates embodiments of methods 400 for exchanging customers between service providers in a computing environment. In this example, the method can likewise comprise multiple steps, including identifying 410 a customer for an originating service provider; assessing 420 a relative proximity of the customer with respect to i) location of a new service provider to the customer or ii) location of the new service provider to other customers of the new service provider, said assessing done using a processor for statistical weighting of travel time; and assigning 430 a market exchange value to customer based on customer details using the processor. Additional steps can include receiving input 440 from the originating service provider regarding their permission to trade the customer; reassigning 450 the customer to the new service provider based on permission of the originating service provider, the location, and at least in part on the assigned market exchange value of the customer; and notifying 460 the new service provider of any reassigned customer using the processor. Optionally, the customer can be notified of the exchange as well.

In one example, an operation in these methods can include identifying one or more customers from each of a plurality of originating service providers. The originating service provider(s) can be any service provider having one or more customers whom they are willing to exchange. Reasons why an originating service can want to trade a customer can vary from geographic inconvenience to the nature of the task requested by the customer.

Once a customer is identified, a relative proximity of the customer can be assessed with respect to the location of each of a plurality of potential new service providers and/or with respect to the location of each of the plurality of potential new service providers other customers. Potential new service providers are considered to be service providers who are not currently servicing the customer. The assessing of the relative proximity can include a statistical weighting of travel time between one or more customers and a pool of a plurality of other customers receiving services from one or more potential new service providers. In one aspect, the statistical weight can include the travel time between the selected customer and a home base for a potential new service provider. The service providers home base or hub location can be considered because in some situations, the service provider may want to return to the home base, sometimes even unexpectedly, such as for replacement parts, lunch and other labor breaks, staff and employee meetings, managerial functions, etc. In some situations, the closer this home base is to the customer population, the more efficient the work is likely to become.

However, as home bases for service providers do not always correspond to their service areas, this factor may not always be included in the statistical weighting. For example, a service provider may have a plurality of units that service customers in a plurality of geographic areas. In such a situation, it is possible that the service providers home base may be proximate one of the geographic service areas and distant from another service area. If this is the case, the service provider can specify the number of individuals or teams currently performing work and the geographic areas covered by each of the individuals or teams. This information can be used to determine how to efficiently divide the existing customers, how many new individuals or teams might be used to efficiently service all customers, how many new customer need to be acquired in order to achieve profitability across all teams, and/or if a service provider's unit is a good fit for a possible exchange of customers (either internally with a separate unit or externally with a separate service provider).

With the above in mind, consideration of home base location may be relevant to one of the service providers units and not to another. The nature of the tasks performed for a customer by a service provider may also impact the desirability of proximity to a home base location as some task types may benefit from more frequent trips to a home base to pick up additional supplies or tools. The pool of new service providers can be limited prior to the assessment of the relative proximity based on other parameters, including qualification of the service provider to perform a given service requested by the customer, desire of the service provider to receive additional customers, etc.

Input can be received from each of the plurality of service providers regarding their permission to trade customers, prioritized in order of relative proximity, between each of the plurality of each of the service providers. Generally, no exchange or reassignment of customers from a service provider occurs without the permission of the service provider servicing the customer. While not necessarily required, customer permission to be exchanged or reassigned to a new service provider can also be factored into exchange assessments and reassignment decisions.

Reassignment of a customer to a new service provider from a pool of potential new service providers can be carried out as well automatically using a processor. The reassigning can be based on the permission of the customers originating service provider and the assessed relative proximity of the customer to the new service provider or others customers. In some aspects, the reassigning can be based on other factors such as the assigned market exchange value of the customer. In other aspects, the reassignment of a first customer to a new service provider from an originating service provider can be in exchange for reassigning a second customer to the originating service provider. The reassigned second customer can be, but does not have to be, a customer who was previously assigned to the new service provider for the first customer. In some aspects, a plurality of customers can be reassigned to a first new service provider in exchange for the reassigning of a second plurality of customers to the originating service provider. While the exchange or reassignment of one or more customers from one service provider to another can involve as few as two service providers, in one aspect three or more service providers can participate in the exchange or reassignment of customers. In such a situation, it is not required that each of the new service providers also receive a new customer. If a customer is not received by an originating service provider in an exchange, credits can be issued to the originating service provider, as will be explained in greater detail hereinafter. Furthermore, reassignment of a customer to a new service provider can be a permanent reassignment or a temporary reassignment.

Following reassignment, the plurality of service providers of the exchanged customers and the exchanged customers themselves can be notified using a processor. The notification can be through electronic or telephonic means (e.g. email, text, account notifications within a web-based interface, etc.) or by traditional mail services. Although typical, in one aspect of the invention, the reassigned customer is not required to be notified of the reassignment to a new service provider.

In some embodiments, the method of exchanging customers receiving services between service providers can further include assigning a market exchange value for each customer being exchanged based on customer details. Examples of customer details that can be considered in formulating a market exchange value for the customer can include the type of one or more tasks to be performed for the customer, the desired frequency of performance of the one or more tasks for the customer, the timeliness of past payments from the customer, the length of time the customer has been a customer, the number of other tasks the customer has ordered in the past, or any measure of the quality of the customer.

In some aspects, when a customer is reassigned from an originating service provider to a new service provider, a second customer of commensurate market exchange value can be reassigned to that originating service provider. In other aspects, the market exchange value of a customer reassigned from an originating service provider is not commensurate with the market exchange value of a customer reassigned to that originating service provider. When there is a disparity in market exchange value (including when one service provider does not receive a customer, and thus, receives no market value at all) between customers reassigned from an originating service provider and other customers reassigned to that originating service provider, the disparity can be determined and a credit or debit allocated to the originating service provider in an electronic database based on the value of the disparity. This feature allows customers to be reassigned to enhance the efficiency of servicing of the customer without reassignment being predicated on an immediate return of a customer of comparable value. Credits allocated to and accumulated by a service provider and stored in the electronic database can be exchanged for newly assigned or exchanged customers at points in the future.

Once a market exchange value for a customer is determined, the customer can be placed in an electronic customer pool from which customers can be reassigned at some point in the future. Reassignment from the electronic customer pool can be nearly immediate but can also take longer periods of time such as a week, two weeks, or longer. In one aspect, a customer placed into the electronic customer pool for reassignment, but who is not yet reassigned, can be considered to be retained by the originating service provider. Such an arrangement can assure that the customer continued to be serviced while the originating service provider is waiting for reassignment of the customer to a new service provider. In some situations the market exchange value of the customer can be adjusted after placement of the customer into the customer pool.

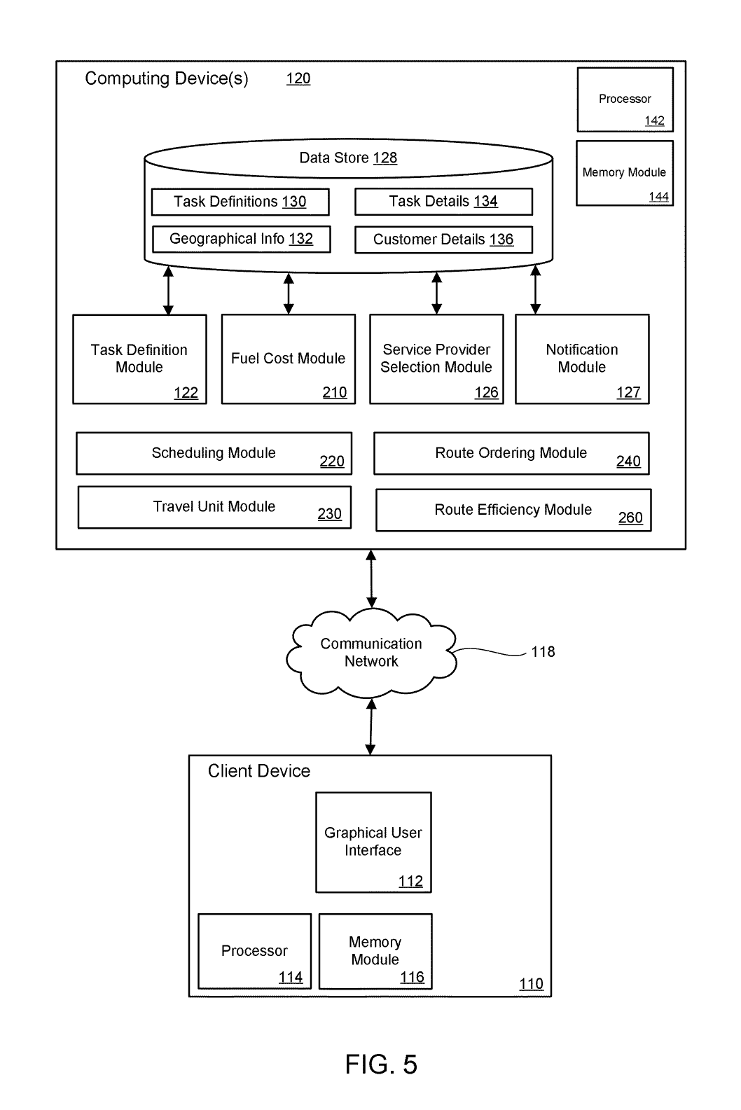

Turning now to FIG. 5, a block diagram illustrating an example of a system for providing computing a route efficiency to adjust the scheduling of tasks based on travel time and estimated fuel consumption is provided. As with the system in FIG. 1, the system can include a client device 110, a communication network 118, and a computing device(s) 120. The computing device 120 includes processor(s) 142, memory module(s) 144, a data store 128, a task definition module 122, a service provider selection module 126, and a notification module 127.

Additionally, however, the computing device(s) 120 can also include a fuel cost module 210 that receives and manages fuel costs for service provider's vehicles. The fuel cost module can receive input regarding fuel costs from the service provider or fuel cost information can be pulled from external sources such as external web pages or databases. A travel unit module 230 is also included in the computing device. The travel unit module can utilize geographical information from the data store to calculate total travel units for a service provider's task order schedule. A scheduling module 220 can also be included that can be utilized in adjusting and ordering of tasks in a task order schedule in conjunction with the route efficiency module 260. The route efficiency module can further calculate the route efficiency based on information provided by the fuel cost module, the scheduling module, and the travel unit module.

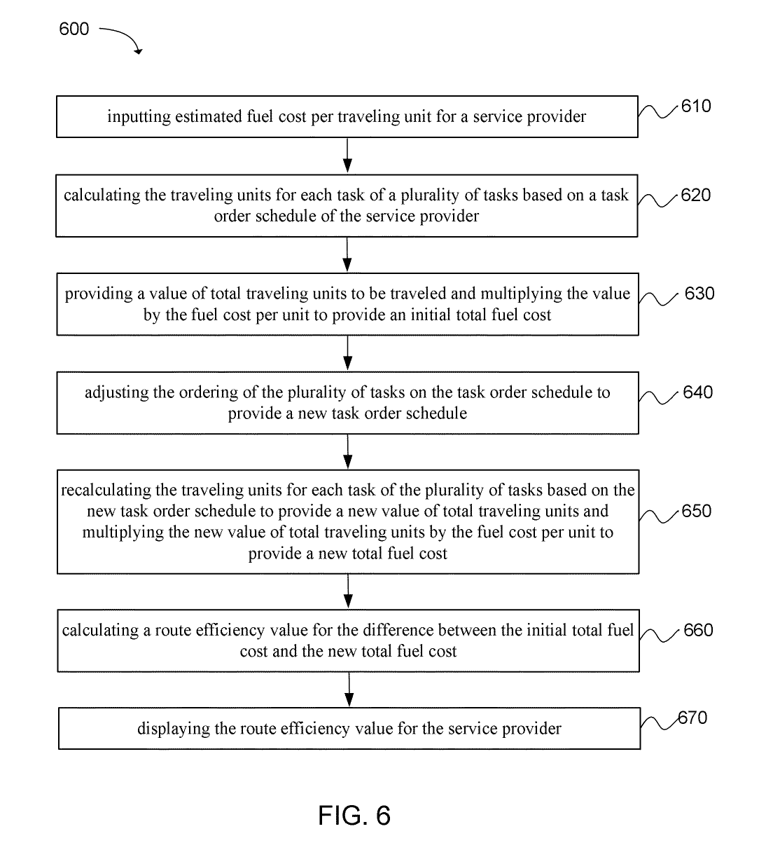

FIG. 6 sets forth methods 600 of computing a route efficiency to adjust the scheduling of tasks based on travel time and estimated fuel consumption. The method can include the operation of inputting 610 estimated fuel cost per traveling unit for a service provider; calculating 620 the traveling units for each task of a plurality of tasks based on a task order schedule of the service provider; and providing 630 a value of total traveling units to be traveled and multiplying the value by the fuel cost per unit to provide an initial total fuel cost. Additional steps can include adjusting 640 the ordering of the plurality of tasks on the task order schedule to provide a new task order schedule; and recalculating 650 the traveling units for each task of the plurality of tasks based on the new task order schedule to provide a new value of total traveling units and multiplying the new value of total traveling units by the fuel cost per unit to provide a new total fuel cost. Still other steps can include calculating 660 a route efficiency value for the difference between the initial total fuel cost and the new total fuel cost; and displaying 670 the route efficiency value for the service provider. By “displaying,” any method of displaying can be used, such as by visual screen, audible message, etc.

As mentioned, after calculation of an initial fuel cost, the ordering of the tasks on the service provider's task order schedule can be adjusted or revised to provide a new task order schedule. The adjusting or revising of the order schedule can be accomplish utilizing a genetic algorithm performed utilizing a processor. The genetic algorithm functions by randomly choosing a finite number of task orderings, calculating the total travel units for each of them and selecting the shortest travel unit value for the collection of tasks on the task order schedule. This can repeated a plurality of times in order to assure that the shortest travel unit value is determined and the new task order schedule selected.

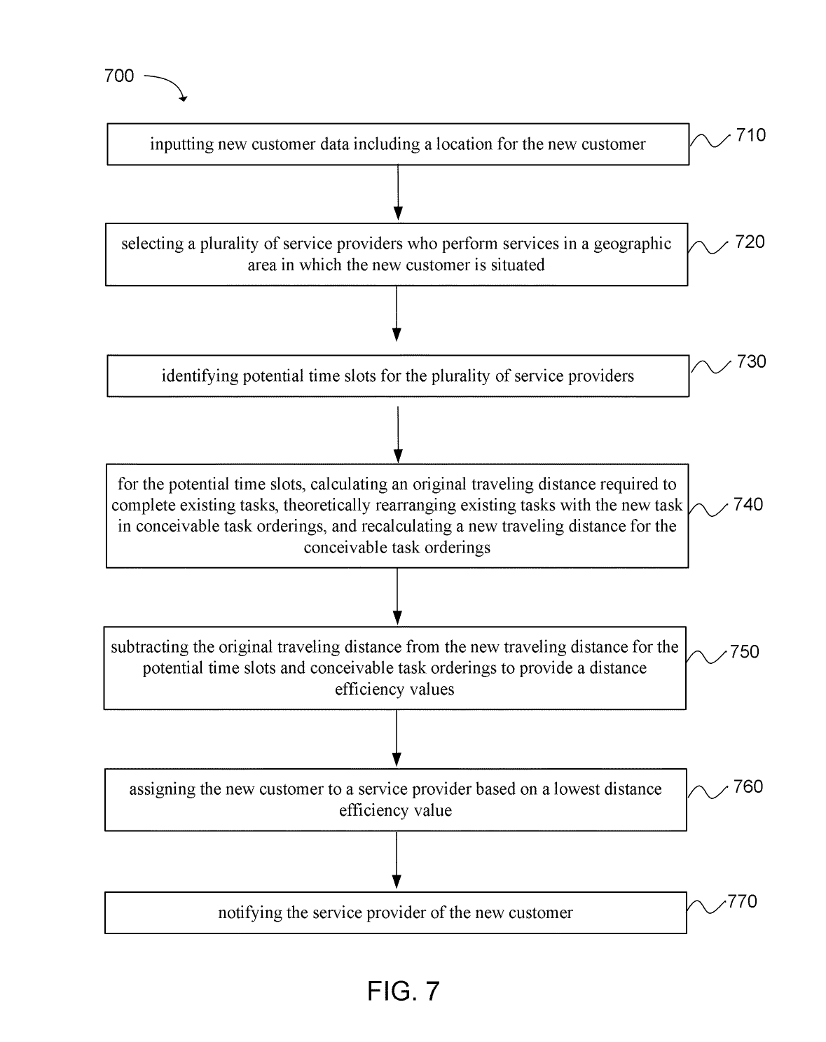

FIG. 7 shows a method of efficiently incorporating a new customer into a service provider's service schedule. For the purposes of the method, a new customer can be a customer that has no current tasks being performed by any service provider or a customer who is requesting a new task be performed. The method includes the operation of inputting 710 new customer data including a location for the new customer; selecting 720 a plurality of service providers who perform services in a geographic area in which the new customer is situated; and identifying 730 potential time slots for the plurality of service providers. An additional step includes, for the potential time slots, calculating 740 an original traveling distance required to complete existing tasks, theoretically rearranging existing tasks with the new task in conceivable task orderings, and recalculating a new traveling distance for the conceivable task orderings. Then, the original traveling distance is subtracted 750 from the new traveling distance for the potential time slots and conceivable task orderings to provide a distance efficiency values. Once this information is determined, a step of assigning 760 the new customer to a service provider based on a lowest distance efficiency value can be carried out. A step of notifying 770 the service provider of the new customer can also be carried out, as well as an optional notification step of notifying the customer of any modification.

Service providers may use accumulated credits that they may have accrued via trades or exchanges of customer in order to purchase new customers entering the system, where those customers have no pre-existing relationship to a service provider. Such customers may enter the system using a general marketing program that is not associated with any specific service provider. While it is important that that customer be geographically situated near a service provider and can be efficiently worked into the service providers schedule, in some situations a new customer may be equally suited for more than one service provider. In such situations the willingness of a service provider to purchase the new customer with existing or purchased credits can be used as a deciding factor in assigning the customer. Paying credits for such new customers may provide the service provider with a priority placement in a queue for receiving new customers entering the system without a service provider association. In accordance with this, it is noted that credits themselves can be monetized and bought and sold independent of customer trading.

In this example, the new customer data can include information regarding any tasks already being performed for the customer by a service provider. Additionally, the step of selecting a plurality of service providers includes assessing the qualification of the service provider to perform the task, and selecting only service providers who have the qualifications for the task. Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. In a computing environment, a method for exchanging customers receiving services between service providers, comprising:
identifying a customer of an originating service provider;
assessing a relative proximity of the customer with respect to i) the location of a new service provider or ii) the location of other customers of the new service provider, using a processor;
receiving input from the originating service provider regarding their permission to trade the customer;
reassigning the customer to the new service provider based on permission of the originating service provider, and based on i) assessed relative proximity of the customer to the new service provider or ii) assessed relative proximity to one or more customer of the new service provider, using a processor; and
notifying the new service provider of an exchange of the customer using the processor.

2. The method of claim 1, further comprising the step of reassigning a second customer to the originating service provider in exchange for the step of reassigning the first customer to the new service provider.

3. The method of claim 1, wherein there are a plurality of originating service providers and a plurality of new service providers as well as a plurality of customers, and multiple customer exchanges occur between originating service providers and new service providers.

4. The method of claim 3, wherein a service provider acts as both an originating service provider and a new service provider in context of the multiple customer exchanges.

5. The method of claim 3, wherein assessing of the relative proximity includes a statistical weighting of travel time between one or more of the plurality of customers relative to one or more of the plurality of new service providers.

6. The method of claim 3, further comprising setting a market exchange value for each customer based on customer details using a processor.

7. The method of claim 6, wherein the customer details include one or more of: the type of one or more tasks to be performed for the customer, a frequency of performance for the one or more tasks to be performed for the customer, the timeliness of past payments from the customer, the length of time the customer has been a customer, the number of other tasks the customer has ordered in the past, or a quantitative measure of the quality of the customer.

8. The method of claim 6, wherein the originating service provider also receives a new customer, and the market exchange value of the customer reassigned from the originating service provider to the new service provider has a value that is commensurate with the market exchange value of new customer reassigned to the originating service provider.

9. The method of claim 6, further comprising placing the customer in an electronic customer pool from which the customers can be reassigned at some point in the future.

10. The method of claim 9, wherein the customer placed in the customer pool by the originating service provider but not reassigned to the new service provider is considered to be retained by the originating service provider.

11. The method of claim 9, wherein the market exchange value of the customer is adjusted after placement of the customer in the customer pool.

12. The method of claim 6, wherein the originating service provider also receives a new customer, and the market exchange value of the customer reassigned from the originating service provider to the new service provider is not commensurate with the market exchange value of the new customer reassigned to the originating service provider.

13. The method of claim 12, wherein a disparity in market exchange value between customers reassigned from the originating service provider and the new service provider compared to the market exchange value of the new customer reassigned to the originating service provider is determined and a credit or debit is allocated to the originating service provider and/or the new service provider in an electronic exchange based on the disparity.

14. The method of claim 6, wherein the market exchange includes a bid/ask market system with a computer based market maker where a profit is generated based on a bid/ask spread.

15. The method of claim 14, wherein credits within the bid/ask market system can be bought and sold independent of trading of customers.

16. The method of claim 1, wherein the reassigning of the customer to the new service provider is a permanent reassignment.

17. The method of claim 1, wherein the reassigning of the customer to the new service provider is a temporary reassignment.

18. The method of claim 1, wherein three or more service providers act as both the originating service provider and the new service provider, and wherein the three or more service providers participate in the reassigning.

19. The method of claim 1, further comprising the step of notifying the customer regarding the new service provider using the processor.

20. The method of claim 1, further comprising the step of receiving input from the new service provider indicating a desire to acquire a new customer.

21. The method of claim 1, further comprising a step of enforcing trade based at least in part on customer input.

22. The method of claim 21, wherein the customer input is used and weighted along a continuum ranging from strongly enforcing trade to weakly enforcing trade.

23. In a computing environment, a method for exchanging customers between service providers, comprising:
identifying a customer for an originating service provider;
assessing a relative proximity of the customer with respect to i) location of a new service provider to the customer or ii) location of the new service provider to other customers of the new service provider, said assessing done using a processor for statistical weighting of travel time;
assigning a market exchange value to customer based on customer details using the processor;
receiving input from the originating service provider regarding their permission to trade the customer;
reassigning the customer to the new service provider based on permission of the originating service provider, the location, and at least in part on the assigned market exchange value of the customer; and
notifying the new service provider of any reassigned customer using the processor.

24. The method of claim 23, further comprising the step of reassigning a second customer to the originating service provider in exchange for the step of reassigning the customer to the new service provider.

25. The method of claim 23, wherein there are a plurality of originating service providers and a plurality of new service providers as well as a plurality of customers, and multiple customer exchanges occur between originating service providers and new service providers.

26. The method of claim 25, wherein a service provider acts as both an originating service provider and a new service provider in context of the multiple customer exchanges.

27. The method of claim 23, wherein the statistical weighting further includes travel time between the customer and a home base for the new service provider.

28. The method of claim 23, wherein the customer details include one or more of: the type of one or more tasks to be performed for the customer, a frequency of performance for the one or more task to be performed for the customer, the timeliness of past payments from the customer, the length of time the customer has been a customer, the number of other tasks the customer has ordered in the past, or a quantitative measure of the quality of the customer.

29. The method of claim 23, wherein the originating service provider also receives a new customer, and the market exchange value of the customer reassigned from the originating service provider to the new service provider has a value that is commensurate with the market exchange value of new customer reassigned to the originating service provider.

30. The method of claim 23, further comprising placing the customer in an electronic customer pool from which the customers can be reassigned at some point in the future.

31. The method of claim 30, wherein the customer placed in the customer pool by the originating service provider but not reassigned to the new service provider is considered to be retained by the originating service provider.

32. The method of claim 30, wherein the market exchange value of the customer is adjusted after placement of the customer in the customer pool.

33. The method of claim 23, wherein the originating service provider also receives a new customer, and the market exchange value of the customer reassigned from the originating service provider to the new service provider is not commensurate with the market exchange value of the new customer reassigned to the originating service provider.

34. The method of claim 33, wherein a disparity in market exchange value between customers reassigned from the originating service provider and the new service provider compared to the market exchange value of the new customer reassigned to the originating service provider is determined and a credit or debit is allocated to the originating service provider and/or the new service provider in an electronic exchange based on the disparity.

35. The method of claim 23, wherein the reassigning of the customer to the new service provider is a permanent reassignment.

36. The method of claim 23, wherein the reassigning of the customer to the new service provider is a temporary reassignment.

37. The method of claim 23, wherein three or more service providers act as both the originating service provider and the new service provider, and wherein the three or more service providers participate in the reassigning.

38. The method of claim 23, further comprising the step of notifying the customer regarding the new service provider using the processor.

39. The method of claim 23, further comprising the step of receiving input from the new service provider indicating a desire to acquire the customer.

40. In a computing environment, a method of computing a route efficiency to adjust the scheduling of tasks based on travel time and estimated fuel consumption using a processor, comprising:
inputting estimated fuel cost per traveling unit for a service provider;
calculating the traveling units for each task of a plurality of tasks based on a task order schedule of the service provider;
providing a value of total traveling units to be traveled and multiplying the value by the fuel cost per unit to provide an initial total fuel cost;
adjusting the ordering of the plurality of tasks on the task order schedule to provide a new task order schedule;
recalculating the traveling units for each task of the plurality of tasks based on the new task order schedule to provide a new value of total traveling units and multiplying the new value of total traveling units by the fuel cost per unit to provide a new total fuel cost; and
calculating a route efficiency value for the difference between the initial total fuel cost and the new total fuel cost; and
displaying the route efficiency value for the service provider.

41. The method of claim 40, wherein adjusting of the ordering of the plurality of tasks on the task order schedule is accomplished utilizing a genetic algorithm.

42. In a computing environment, a method for efficiently incorporating a new customer into a service provider's service schedule using a processor, comprising:
inputting new customer data including a location for the new customer;
selecting a plurality of service providers who perform services in a geographic area in which the new customer is situated;
identifying potential time slots for the plurality of service providers;
for the potential time slots, calculating an original traveling distance required to complete existing tasks, theoretically rearranging existing tasks with the new task in conceivable task orderings, and recalculating a new traveling distance for the conceivable task orderings;
subtracting the original traveling distance from the new traveling distance for the potential time slots and conceivable task orderings to provide a distance efficiency value;
assigning the new customer to a service provider based on a lowest distance efficiency value; and
notifying the service provider of the new customer.

43. The method of claim 42, wherein the new customer data includes information regarding any tasks already being performed for the customer by a service provider.

44. The method of claim 42, wherein the step of selecting a plurality of service providers includes assessing the qualification of the service provider to perform the task, and selecting only service providers who have the qualifications for the task.

45. The method of claim 42, further comprising the step of notifying the customer regarding the new service provider.
